(19) United States
(12) Patent Application Publication
(10) Pub. No.: US 2025/0302025 A1
(43) Pub. Date: Oct. 2, 2025

(54) FISHING BOBBER WITH DIRECTIONAL BUOYANCY INDICATOR AND ATTACHED WEIGHT INDICATOR

(71) Applicant: MICHAEL WATHEN, OWENSVILLE, IN (US)

(72) Inventor: MICHAEL WATHEN, OWENSVILLE, IN (US)

(21) Appl. No.: 19/193,681

(22) Filed: Apr. 29, 2025

Related U.S. Application Data
(63) Continuation-in-part of application No. 18/542,914, filed on Dec. 18, 2023.

(51) Int. Cl. A01K 93/02

(52) U.S. Cl. CPC A01K 93/02

(57) ABSTRACT

A fishing bobber with directional buoyancy includes a trunk, a limb, and a mechanism for engaging a fishing line. The trunk has a weighted end that sits below water and a buoyant end that remains above. The limb extends outward from the buoyant end and holds the line-engaging mechanism. When a fish strikes and swims, the limb rotates in the direction of the movement, providing a visual cue to the angler. A cantilever allows the bobber to change position depending on whether the hook is weighed down by bait.

### BACKGROUND OF THE INVENTION

### Field of the Invention

This disclosure relates generally to bobbers for attachment to fishing lines, and more particularly to a bobber capable of indicating the location of a fish relative to the bobber and the direction in which the fish is moving. The bobber is also capable of indicating to an angler above the surface whether the bait is still on the hook below the surface.

### Description of the Related Art

Floating fishing bobbers have been long used, serving the dual functions of suspending a bait laden hook a desired distance below the surface of the water, and of providing visual indication of the presence of a fish taking the bait. Large fish may take both hook and bait into their mouths and tug to completely sink the bobber, which provides an unquestionable notice of the fish's presence. Smaller fish may only nibble at the bait on the hook, causing only a minor, perhaps unnoticed response of the bobber. In the latter event, especially if the bobber is distant from the angler, the presence of the fish may go undetected. Fishing is touted as, and is in reality among, the most relaxing of avocations. As such, fishing can be accompanied by drowsiness and the lack of alert perceptivity needed to notice small bobber disturbances. Small disturbances may even be seen when attributed to gentle waves and breezes rather than to the fish.

Several fishing bobbers have been designed to shift position upon the water when the bait line is tugged. U.S. Pat. No. 3,323,247, comprises a hollow floating ball with an extending stem attached oppositely to the point of fishing line connection. At rest, this bobber reclines upon the surface of the water. The reclining position of the stem upon the surface of the water is maintained by a small float positioned outwardly on the stem. Strong tugs upon the baited hook rotates the ball, raising the stem into the air. Smaller tugs might also alert the angler, the stem then partially rising and falling. The bobber response is largely proportional to the strength of the tug upon the bait line, ranging from small upward motions of the stem to movement to a directly upright position of the stem. After the fish has left, if not hooked, the bobber, because of unstable equilibrium resulting from the center of buoyancy being below the center of gravity, immediately assumes its original reclining position with the stem lying along the water. If the angler's attention wanders and the fish successfully takes the bait without being hooked, the angler may unknowingly continue to fish with a baitless hook.

U.S. Pat. No. 4,300,304 discloses a hollow floating ball with an extending rod called a “nibbler stick”. The principle of operation is very similar to the previously discussed design. The nibbler stick provides improved noticeability by multiplying the motion of the ball. As with the preceding design, the bobber assembly is stable only with the extending stem lying along the water surface. U.S. Pat. No. 4,845,885 discloses a bobber assembly including a heavy central washer of metallic or other dense material at the center of a hollow bulbous body. A stem extends oppositely to the point of attachment of the fishing line and the baited hook line. The weight in this location causes the bobber assembly to float in stable horizontal position. A tug by a fish unbalances the bobber equilibrium, rotating it to a vertical position. Should the fish abandon the bait on the hook, or detach it without being hooked, the bobber then assumes a stable horizontal position upon the water, perhaps with a baitless hook.

U.S. Pat. No. 6,389,736 discloses a fishing bobber design of elongate construction, having internal unattached rolling weights, so that the bobber will remain in stable horizontal position or in stable vertical position upon the body of water. The nibble of a fish upon the bait tips the bobber from stable horizontal position to a very noticeable stable vertical position, in which it remains until again placed into the stable horizontal position upon the water.

However, none of the aforementioned bobbers provide an indication as to where the fish is located relative to the bobber or what direction a fish that has struck the bait is swimming. Accordingly, there is a need for a floating fish bobber that not only indicates the presence of a fish on the hook, but also indicates the location of that fish relative to the bobber and the direction in which the hooked fish is swimming or the direction from which the hit is coming.

### SUMMARY OF THE INVENTION

It is therefore an object of the present invention to provide a bobber that not only provides a visual indicator of a fish strike but also provides a visual indicator to the angler as to the location of the fish and the direction in which it is swimming.

It is also an object of the invention to provide a fishing bobber that exhibits a reduced, or a more gradual, resistance in the line given that, when a fish senses resistance from the bait or line, it will often drop the bait and move on after perceiving a false presentation.

The present invention meets these objects by providing a fishing bobber with directional buoyancy indicator that includes a trunk, a limb and first means for engaging a segment of the fishing line. When a fish strikes the hook at the end of the line and continues swimming, the limb rotates in the direction in which the fish is swimming providing a visual indicator to the angler.

According to one presently preferred embodiment of the invention, there is provided a fishing bobber with directional buoyancy indicator for attachment to a fishing line comprising a trunk, a limb and first means for engaging a segment of the fishing line. The trunk may include a weighted first end and a buoyant second end such that when in use, the weighted first end is below the surface of the water and the buoyant second end is above the surface of the water substantially above the first end. The limb has a first end affixed to the trunk proximate to the second end of the trunk and extending radially outwardly therefrom. The first means for engaging a segment of the fishing line is positioned proximate to a second free (or terminal) end of the limb.

The trunk of the fishing bobber may be hollow and may include a plurality of openings in an outer surface thereof between the first weighted end and the second buoyant end. The plurality of openings may be a plurality of vertical slots. The trunk may be a cylinder having a first sealed cap at the first weighted end and a second sealed cap at the second buoyant end.

A sealed air pocket may be provided at the second buoyant end of the trunk for providing buoyancy to the bobber. The trunk may be formed from a plastic material and the plastic material at the first weighted end has a density greater than the density of the first end of the trunk.

The limb may extend radially outwardly from the trunk in a plane that is substantially perpendicular to a central axis of the trunk. A second means for engaging a second segment of fishing line proximate to the buoyant second end of the trunk may be provided. In this configuration, the first line segment engaging means engages a segment of fishing line that is closer to a hook at a terminal end of the fishing line.

Alternatively, the limb may extend radially outwardly from the trunk at a downward angle toward the first weighted end of the trunk. A second means for engaging a second segment of fishing line proximate to the buoyant second end of the trunk may be provided. In this configuration, the first line segment engaging means engages a segment of fishing line that is closer to a hook at a terminal end of the fishing line. The first fishing line segment engaging means and the second fishing line segment engaging means may each comprise a line eye to which the respective segments of fishing line are secured.

According to a further alternative embodiment, the limb extends radially outwardly from the trunk at an upward angle away from the first weighted end of the trunk. The first fishing line segment engaging means may comprise a line eye to which the segment of fishing line is secured.

According to a further embodiment of the invention, a sleeve is provided that is removably attached to an outer surface of the limb proximate to the second end thereof. The sleeve is configured to fix the line to the bobber.

According to a further embodiment, the first fishing line segment engaging means comprises an opening in the limb through which the line passes and the second fishing line segment engaging means comprises a line eye through which the line passes.

Yet a further embodiment of the invention provides a weighted magnet located at the weighted first end of the trunk. The magnet provides both weigh and means for removably attaching additional weights.

These and other objects, features and advantages of the present invention will become apparent from a review of the following drawings and detailed description of the preferred embodiments of the invention.

### BRIEF DESCRIPTION OF THE DRAWINGS

The present invention can best be understood in connection with the accompanying drawings. It is noted that the invention is not limited to the precise embodiments shown in the drawings, in which:

FIG. 1 is a perspective view of a fishing bobber with directional buoyancy indicator according to one presently preferred embodiment of the invention.

FIG. 2 is a side sectional view of the fishing bobber with directional buoyancy indicator shown in FIG. 1.

FIG. 3 is a side sectional view of the fishing bobber with directional buoyancy indicator according to a first alternative embodiment.

FIG. 4 is a side sectional view of the fishing bobber with directional buoyancy indicator according to a second alternative embodiment.

FIG. 5A is a top view of the fishing bobber with directional buoyancy indicator shown in FIG. 1 prior to a fish strike.

FIG. 5B is a top view of the fishing bobber with directional buoyancy indicator shown in FIG. 1 and FIG. 5A after a fish has struck the hook and moved to the left.

FIG. 6A is a perspective view of a fishing bobber with directional buoyancy indicator according to an alternative preferred embodiment of the invention.

FIG. 6B is a perspective view of the fishing bobber with directional buoyancy indicator shown in FIG. 6A shown here in a partially assembled configuration.

FIG. 7 is a perspective view of a fishing bobber with directional buoyancy indicator according to a further alternative preferred embodiment of the invention.

FIG. 8 is a perspective view of a fishing bobber with directional buoyancy indicator according to a further alternative preferred embodiment of the invention.

FIG. 9 is a perspective view of a fishing bobber with directional buoyancy indicator and bait indicator according to a further alternative preferred embodiment of the invention.

FIG. 10 is a cutaway perspective view of the bobber shown in FIG. 9.

FIG. 11 is a side elevation view of the bobber shown in FIG. 9 shown floating on the water with no bait on the hook.

FIG. 12 is a side elevation view of the bobber shown in FIG. 9 shown floating on the water with bait on the hook.

FIG. 13 is a perspective cutaway view of a fishing bobber with directional buoyancy indicator and bait indicator according to a further alternative preferred embodiment of the invention.

FIG. 14 is a cutaway side elevation view of the bobber shown in FIG. 13.

FIG. 15 is a side elevation view of the bobber shown in FIG. 13 shown floating on the water with no bait on the hook.

FIG. 16 is a side elevation view of the bobber shown in FIG. 13 shown floating on the water with bait on the hook.

FIG. 17 is a side elevation view of a fishing bobber with directional buoyancy indicator and bait indicator according to a further alternative preferred embodiment of the invention, shown floating on the water with no bait on the hook.

FIG. 18 is a side elevation view of the bobber shown in FIG. 17 shown floating on the water with bait on the hook.

FIG. 19 is a bottom view of the bobber shown in FIG. 17.

FIG. 20A is a top perspective view of a fishing bobber with directional buoyancy indicator and bait indicator according to a further alternative preferred embodiment of the invention.

FIG. 20B is a side section view of the bobber shown in FIG. 20A.

### DETAILED DESCRIPTION OF THE INVENTION

For the purposes of promoting an understanding of the principles of the embodiments described herein, reference is now made to the drawings and descriptions in the following written specification. No limitation to the scope of the subject matter is intended by the references. This disclosure also includes any alterations and modifications to the illustrated embodiments and includes further applications of the principles of the described embodiments as would normally occur to one skilled in the art to which this document pertains.

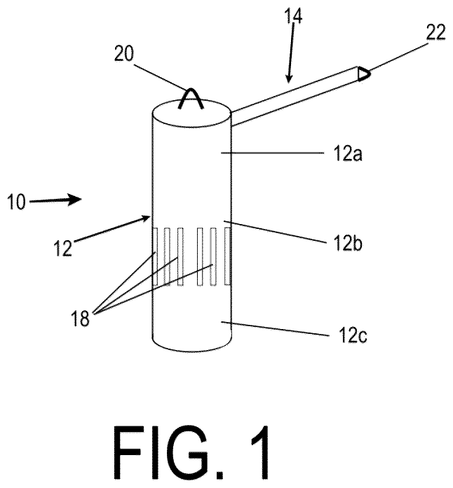

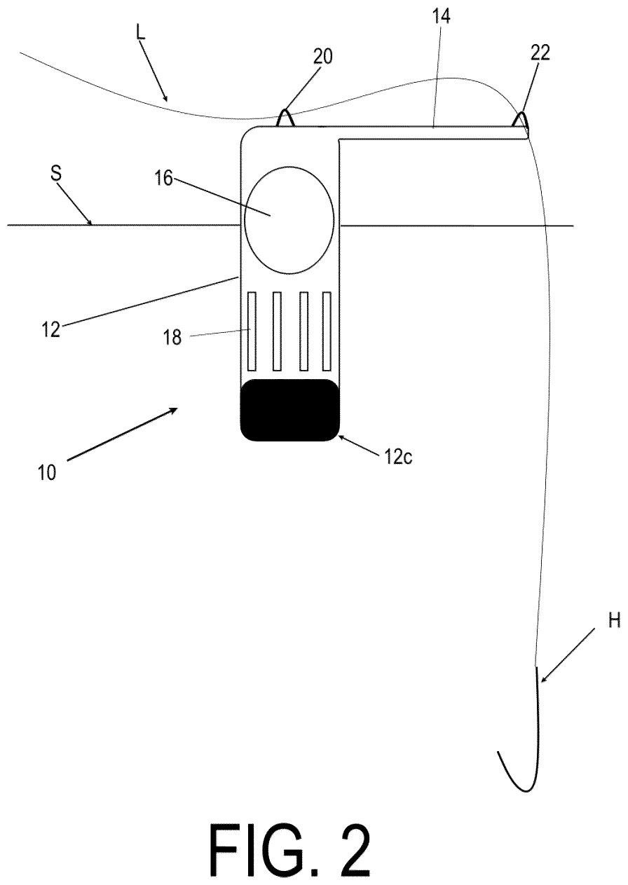

As best shown in FIG. 1, one presently preferred embodiment of the invention comprises a fishing bobber 10 with directional buoyancy indicator. The bobber 10 includes a trunk 12, a portion of which floats above the surface of the water, and a limb 14 extending radially outwardly from the trunk 12 at or near a top section 12a of the trunk 12 above the surface of the water. The trunk 12 may by cylindrically shaped. According to one preferred embodiment of the invention, the bottom section 12c of the trunk 12 is weighted in order to ensure that the central axis of the trunk 12 is perpendicular to the surface of the water. The top section 12a of the trunk 12 may include an air pocket 16 (as shown in FIG. 2) to keep the upper portion of the bobber floating above the surface of the water. The bottom section 12c of the trunk 12 can be weighted by forming it from or otherwise incorporating a plastic or other material having a density greater than the density of the materials in the middle section 12b and upper section 12a of the trunk 12. The middle section 12b of the bobber trunk 12 may also include one or more openings 18 therein to allow water to pass through the bobber 10 thereby adding weight to the bottom section 12c of the trunk, and thus adding stability to the bobber 10.

A first line eye 20 may be located at or near the top surface of the trunk 12 and a second line eye 22 may be located at or near the free (or terminal) end of the limb 14. As shown in FIG. 2, the bobber 10 is secured to the line L, by passing the line through the first line eye 20, then through the second line eye 22 before it is connected to a hook H at the free (or terminal) end of the line L. The line L is secured to the bobber 10 at each of the line eyes 20, 22 and the depth of the hook H is determined by the fisherman by the length of line between the hook H and the second line eye 22. When a fish engages the hook H, the line L will be pulled and the free end of the limb 14 will rotate in the direction that the fish is taking the hook H.

The limb 14 of the bobber 10 shown in FIG. 2 extends radially outwardly from the trunk 12 and is oriented substantially perpendicular to the longitudinal axis of the trunk 12 and substantially parallel to the surface S of the water. Preferably, the free end of the limb 14 is about 1.5 inches above the surface S when in use.

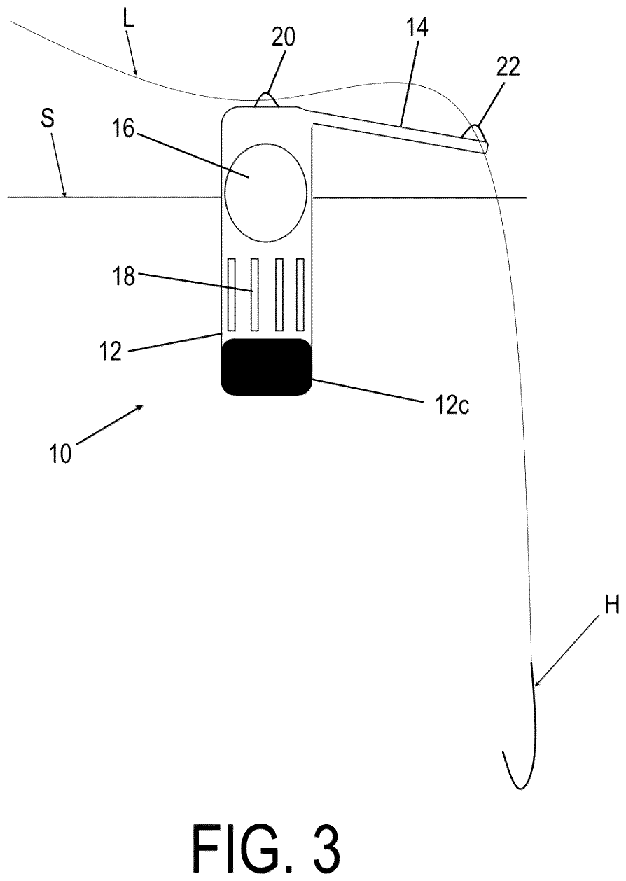

According to a first alternative embodiment as shown in FIG. 3, the limb 14 is angled downwardly toward the surface S of the water such that the free end of the limb 14 is closer to the surface S than the end that is affixed to the top of the trunk 12. In this embodiment, the free end of the limb 14 is also about 1.5 inches above the surface S when in use, while the end affixed to the trunk 12 is about 2.5 inches above the surface S.

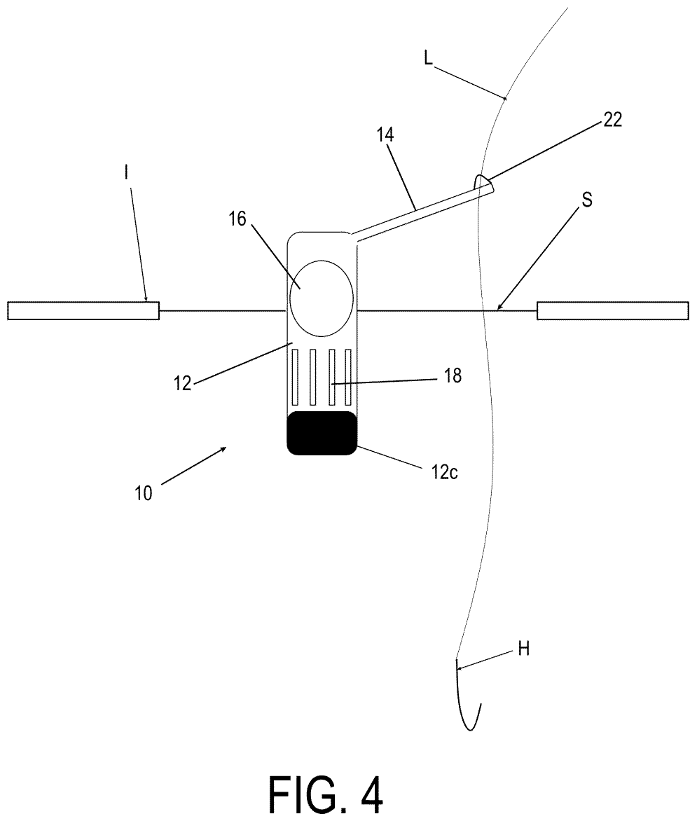

A second alternative embodiment, as shown in FIG. 4, is useful for ice fishing where a hole is cut in the frozen surface I of a body of water leaving a small opening water surface S. Because the opening is small and the thickness of the ice may vary, the limb 14 is angled upwardly away from the surface S of the water such that the free end of the limb 14 is further from the surface S than the end that is affixed to the top of the trunk 12. In this embodiment, the free end of the limb 14 is also about 3 inches above the surface S when in use, while the end affixed to the trunk 12 is about 1.5 inches above the surface S. Also, when this embodiment is deployed, the line L need only pass through and be secured to the line eye 22 at the free end of the limb 14.

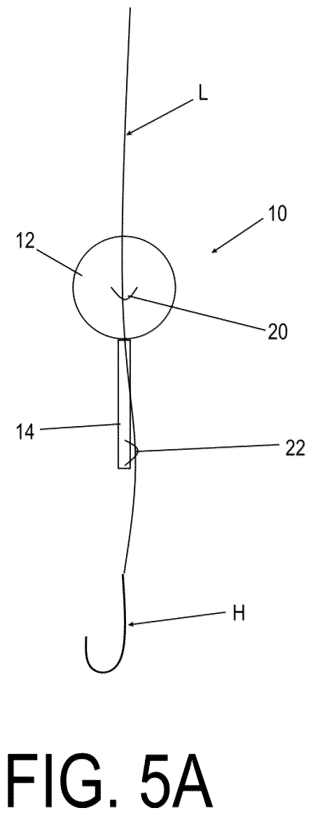

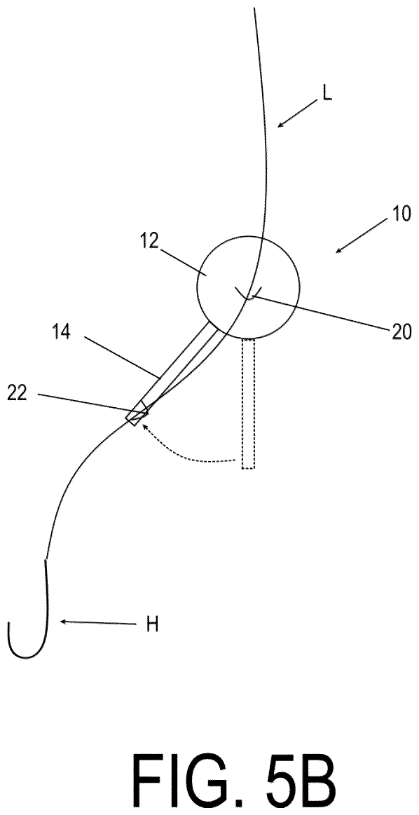

FIG. 5A and FIG. 5B depict the bobber 10 in operation. As shown in FIG. 5A, when there is not a fish on the hook H, the limb 14 will essentially point in a neutral direction. However, as depicted in FIG. 5B, when a fish strikes the hook H and pulls it in a horizontal direction, the limb 14 will rotate in that direction indicating to the angler that there is a fish on the hook and what general direction that fish is swimming.

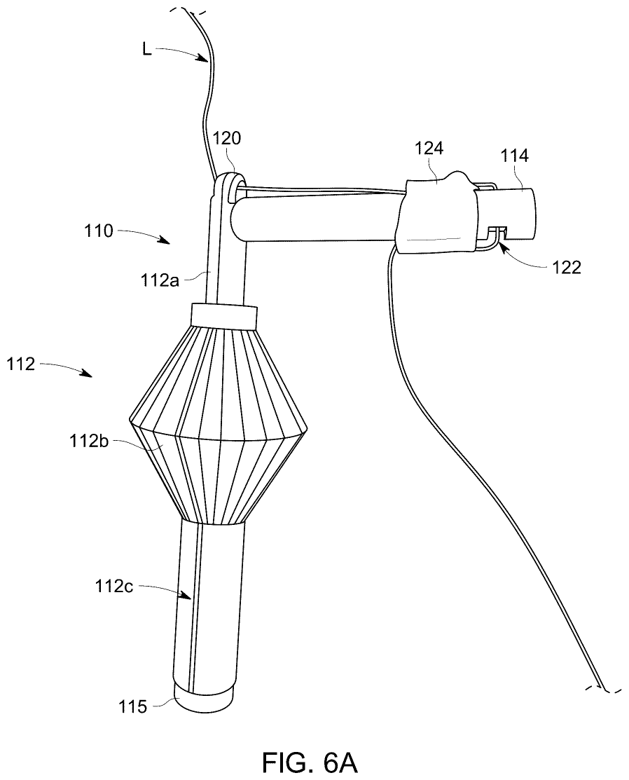

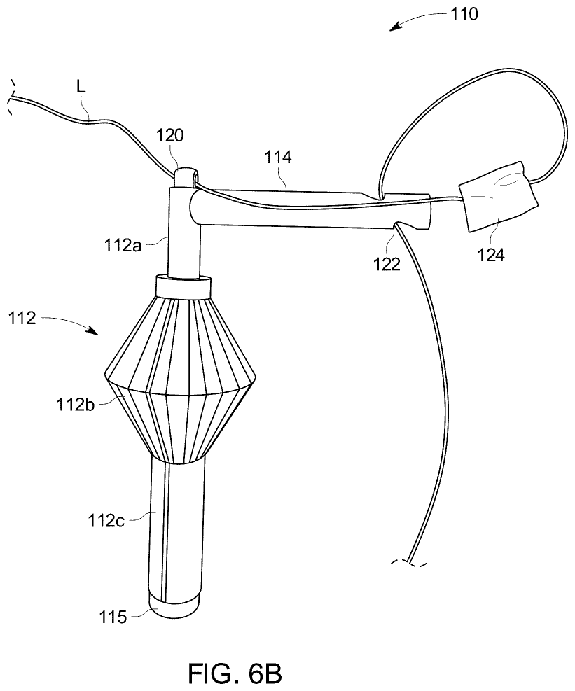

FIG. 6A and FIG. 6B show a bobber 110 according to a further preferred embodiment. The bobber 110 according to this embodiment is like the embodiments shown in FIG. 1-FIG. 5B wherein like reference numerals indicate like components. As in the prior embodiments, the bobber 110 includes a trunk 112, a portion of which floats above the surface of the water, and a limb 114 extending radially outwardly from the trunk 112 at or near a top section 112a of the trunk 112 above the surface of the water. The trunk 112 may include a diamond-shaped float 112b that is designed to float at the surface of the water when in use. The bottom section 112c of the trunk 112 may include a magnet embedded at or near the bottom thereof. Weight(s) can be added to the bobber 110 by adding additional magnets or metal discs 115 to the bottom of the trunk 112c. The magnet at the base of the trunk 112c releasably holds the magnet/weight 115 in place, thereby adding weight if desired. Additional magnets/weights 115 can be stacked on the first magnet/weight 115 to add additional weight if desired. The diamond shaped float section 112b of the trunk 112 may include an air pocket (not shown) to keep the upper portion of the bobber 110 floating above the surface of the water.

A first line eye 120 may be located at or near the top surface of the trunk 112 and an opening 122 extending through the limb 114 near the free end thereof is also provided. As shown in FIG. 6B, the bobber 110 is secured to the line L, by passing the line L through the first line eye 120, then through the opening 122 before it is connected to a hook (not shown) at the free end of the line L. Between the line eye 120 and the opening 122, the line L passes through a sleeve 124. As shown in FIG. 6A, once the length of line below the bobber 110 is selected by the fisherman, the sleeve 124 is then slid onto the end of the limb 114 thereby securing the line to the bobber 110.

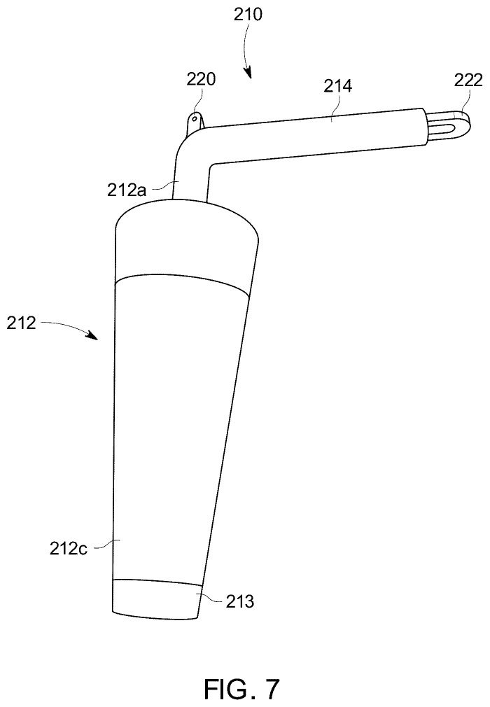

FIG. 7 shows a bobber 210 according to a further preferred embodiment. The bobber 210 according to this embodiment is like the embodiments shown in FIG. 1-FIG. 6B wherein like reference numerals indicate like components. As in the prior embodiments, the bobber 210 includes a trunk 212, a portion of which floats above the surface of the water, and a limb 214 extending radially outwardly from the trunk 212 at or near a top section 212a of the trunk 212 above the surface of the water. The trunk 212 is generally a tapered cylinder that has a relatively large diameter at the top end 212a, and a smaller diameter at the bottom end 212c. The bottom end 212c of the trunk 212 may include a magnet 213 embedded at or near the bottom thereof. Weight(s) can be added to the bobber 210 by adding additional magnets or metal discs (not shown) to the bottom of the trunk 212c. The magnet at the base of the trunk 212c releasably holds the magnet/weight in place, thereby adding weight if desired.

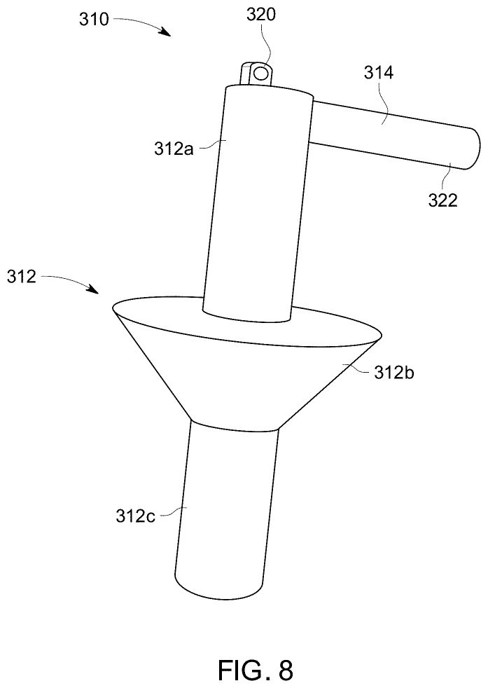

FIG. 8 shows a bobber 310 according to a further preferred embodiment. The bobber 310 according to this embodiment is like the embodiments shown in FIG. 1-FIG. 7 wherein like reference numerals indicate like components. As in the prior embodiments, the bobber 310 includes a trunk 312, a portion of which floats above the surface of the water, and a limb 314 extending radially outwardly from the trunk 312 at or near a top section 312a of the trunk 312 above the surface of the water. The trunk 312 may include a half diamond-shaped float 312b that is designed to float at the surface of the water when in use. The lower section of the float resembles that of the diamond shaped float shown in FIG. 6A and FIG. 6B, but the upper portion is absent leaving a substantially flat top surface. The top section 312a and/or the half diamond-shaped float 312b of the trunk 312 may include an air pocket (not shown) to keep the upper portion of the bobber 310 floating above the surface of the water.

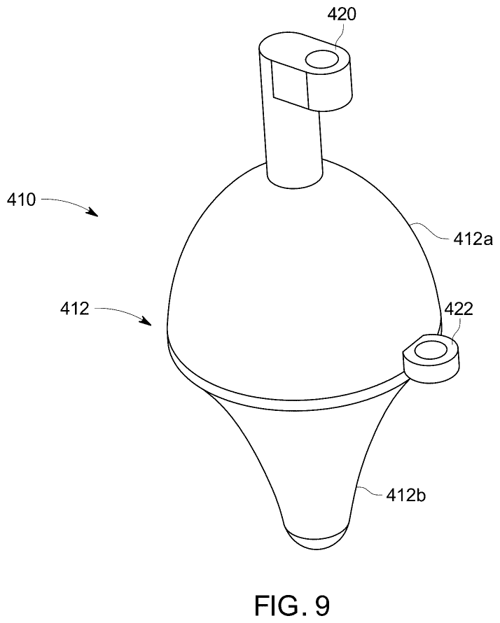

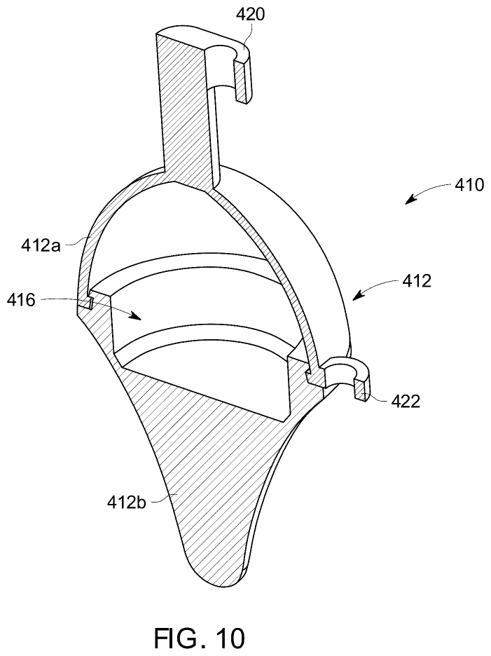

FIG. 9-FIG. 12 show a bobber 410 according to a further preferred embodiment. The bobber 410 according to this embodiment not only has a directional indicator like the previous embodiments, it includes a visual indicator to the angler above the surface of whether there is still bait on the hook H. As in the prior embodiments, the bobber 410 includes a trunk 412, a top portion 412a of which floats above the surface of the water, W and a lower, weighted portion 412b that is designed to sit below the surface of the water when in use. The top section 412a of the trunk 412 may include an air pocket 416 to keep the upper portion of the bobber floating above the surface of the water W. The top section 412a and bottom section 412b of the trunk 412 can be molded from plastic and designed to snap together to form the entire trunk 412 having the air pocket 416 in the upper section 412a as shown in FIG. 10.

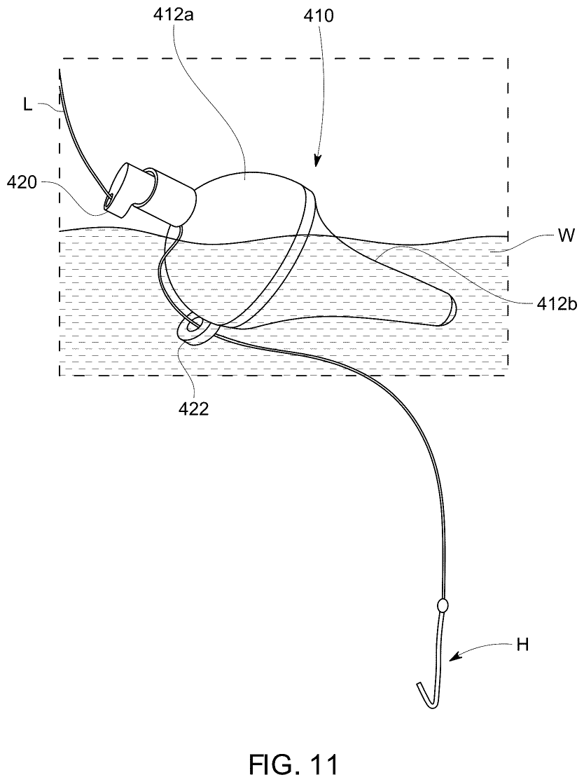

A first line eye 420 may be located at or near the top of the trunk top section 412a and a second line eye 422 may be located at or near the bottom of the upper trunk section 412a along the outer periphery thereof. As shown in FIG. 11, the bobber 410 is secured to the line L, by passing the line L through the first line eye 420, then through the second line eye 422 before it is connected to a hook H at the free end of the line L. The line L is secured to the bobber 410 at each of the line eyes 420, 422 and the depth of the hook H below the water's surface is determined by the fisherman by the length of line between the hook H and the second line eye 422.

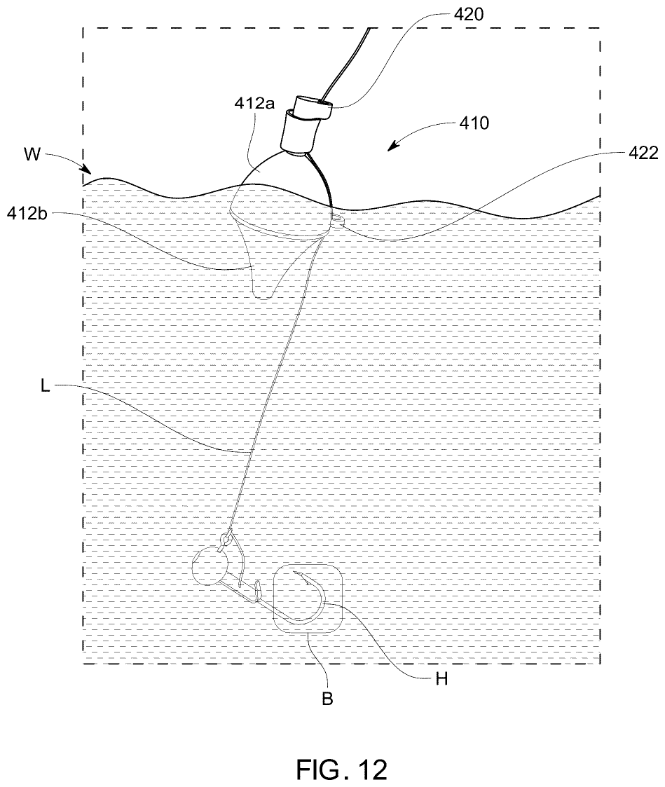

As shown in FIG. 11, when there is no bait on the hook H, the air pocket 416 in the upper section 412a of the trunk 412 and the weighted bottom section 412b cause the bobber 410 to lay almost on its side, indicating that there is no bait on the hook H and/or an insufficient amount of weight (e.g., split shot weight) attached to the line L between the second line eye 422 and the hook H. When there is bait B on the hook H, as shown in FIG. 12, the weight of the bait B pulls down on the line L causing a cantilevered action at the trunk 412 at between the first line eye 420 and second line eye 422. The weight of the bait B pulling down on the line L thus causes the bobber 410 to sit is a more upright position as shown in FIG. 12, indicating to the angler above the surface W that there is bait on the hook H below the surface W.

For the embodiment shown in FIG. 9-FIG. 12, when a fish engages the hook H and swims away in a given direction, the point where the line L engages the second line eye 422 will be pulled in that direction causing the trunk 412 to rotate in that direction relative to the first line eye 420 which is located substantially at the center of the trunk 412. This rotation indicates to the angler that a fish is on the line and also indicates the direction that the fish is swimming. Contrasting and/or other colors and/or patterns can be added to the upper section 412a and/or bottom section 412b of the trunk 412 to provide further visual assistance to the angler in making this determination.

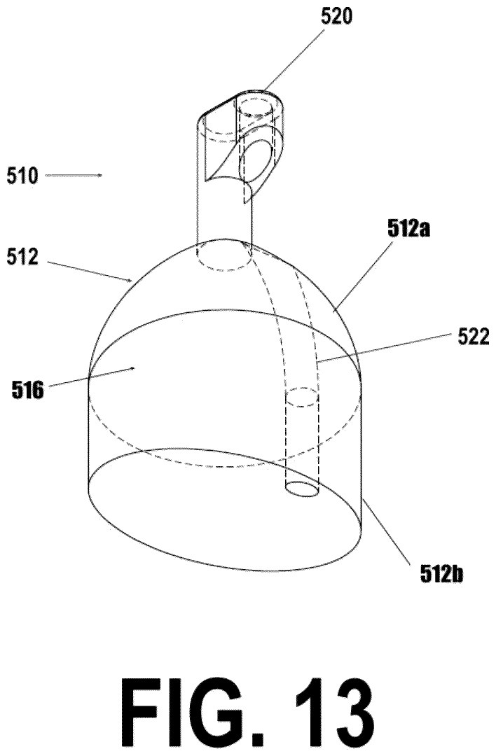

FIG. 13-FIG. 16 show a bobber 510 according to a further preferred embodiment. The bobber 510 according to this embodiment also has both a directional indicator and a bait present indicator. The bobber 510 according to this embodiment includes a trunk 512, a top portion 512a of which floats above the surface of the water W and a lower, weighted portion 512b that is designed to sit below the surface of the water W when in use. The top section 512a of the trunk 512 may include an air pocket 516 (as best shown in FIG. 13) to keep the upper portion of the bobber floating above the surface of the water W. The bottom section 512b of the trunk 512 may have a sloped bottom 530 which alters the balance of the bobber 510 putting more weight on one side thereof at the bottom, which creates the cantilevered action necessary to perform the bait present indicator function.

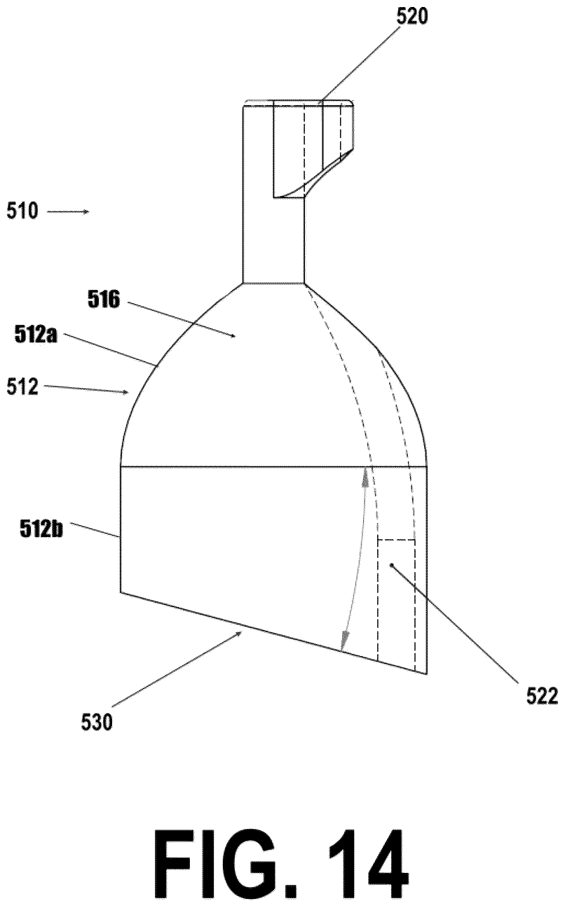

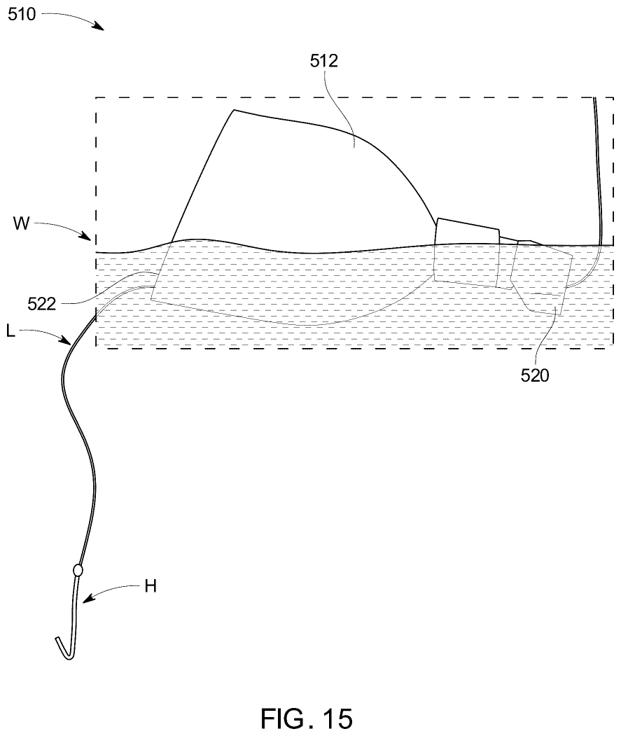

A first line eye 520 may be located at or near the top of the trunk top section 512a. Instead of a second line eye, the bobber 510 according to this embodiment includes a channel 522 passing through the interior portion of the trunk 512. As best shown in FIG. 13 and FIG. 14, the channel 522 begins in the upper section 512a and ends at the lower section of the slope 530 at or near the periphery of the bottom section 512b. As shown in FIG. 15, the bobber 510 is secured to the line L, by passing the line L through the first line eye 520, then through the channel 522 before it is connected to a hook H at the free end of the line L. The line L is secured to the bobber 510 at the first line eye 520 and the depth of the hook H below the surface W is determined by the fisherman by the length of line between the hook H and the point where the line exits the channel 522.

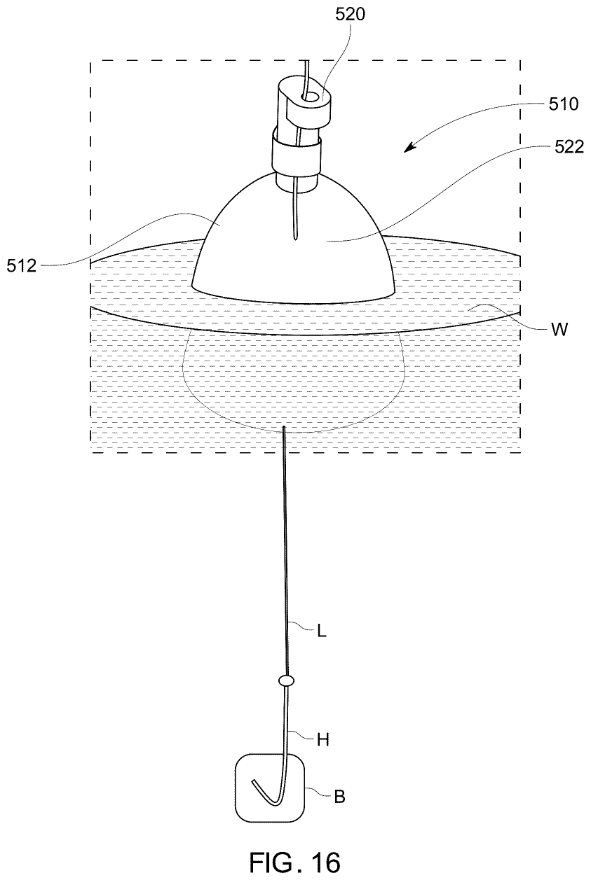

As shown in FIG. 15, when there is no bait on the hook H and/or an insufficient amount of weight (e.g., slip shot weight) attached to the line L between the channel 522 and hook H, the air pocket 516 in the upper section 512a of the trunk 512 and the slanted/side-weighted bottom section 512b cause the bobber 510 to lay almost on its side, indicating that there is no bait on the hook H and/or insufficient weight attached to the line L between the channel 522 and hook H. When there is bait B on the hook H and/or sufficient weight attached to line L between channel 522 and hook H (collectively or individually, for purposes of this specification, the “attached weight”), as shown in FIG. 16, such attached weight pulls down on the line L causing a cantilevered action at the trunk 512 at between the first line eye 520 and channel 522. The attached weight pulling down on the line L thus causes the bobber 510 to sit in a more upright position as shown in FIG. 16, indicating to the angler above the surface W that there is a sufficient amount of attached weight on the hook H and/or the line L between channel 522 and hook H below the surface W.

For the embodiment shown in FIG. 13-FIG. 16, when a fish engages the hook H and swims away in a given direction, the point where the line L engages the bottom of the channel 522 will be pulled in that direction causing the trunk 512 to rotate in that direction relative to the first line eye 520 which is located substantially at the center of the trunk 512. This rotation indicates to the angler that a fish is on the line L and also indicates the direction that the fish is swimming. Contrasting and/or other colors and/or patterns can be added to the upper section 512a and/or bottom section 512b of the trunk 512 to provide further visual assistance to the angler in making this determination.

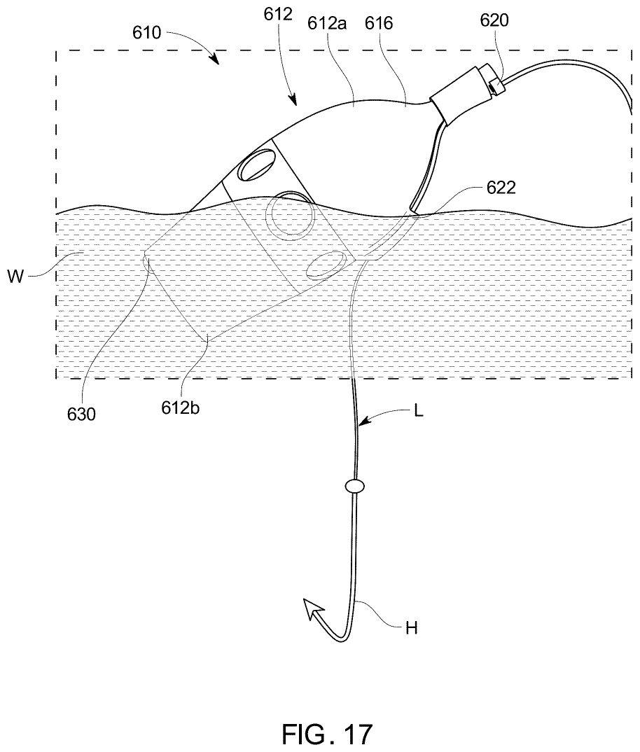

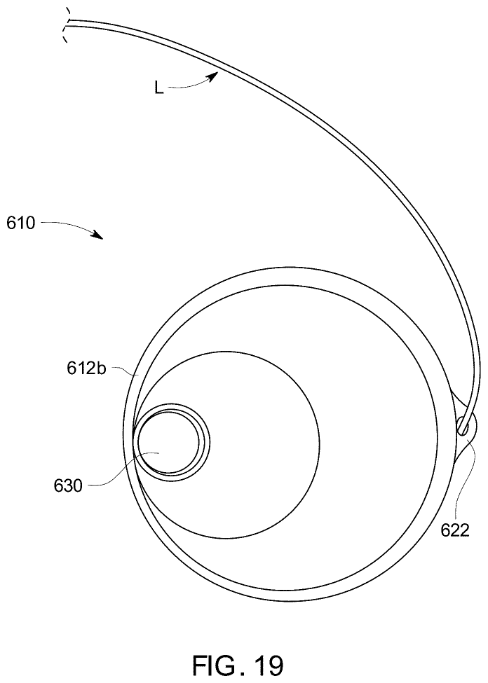

FIG. 17-FIG. 19 show a bobber 610 according to a further preferred embodiment. The bobber 610 according to this embodiment also has both a directional indicator and a bait present indicator. The bobber 610 according to this embodiment includes a trunk 612, a top portion 612a which floats above the surface of the water W and a lower, weighted portion 612b that is designed to sit below the surface of the water when in use. As best shown in FIG. 19, the bottom portion 612b is weighted by placing a weight, such as a lead weight 630 at or near to lower edge of the bottom section 612b at the periphery thereof. Alternatively, the weighted region in the lower section 612b can be formed by providing more, or higher density, plastic in the area where more weight is desired to create the cantilever effect for attached weight indication.

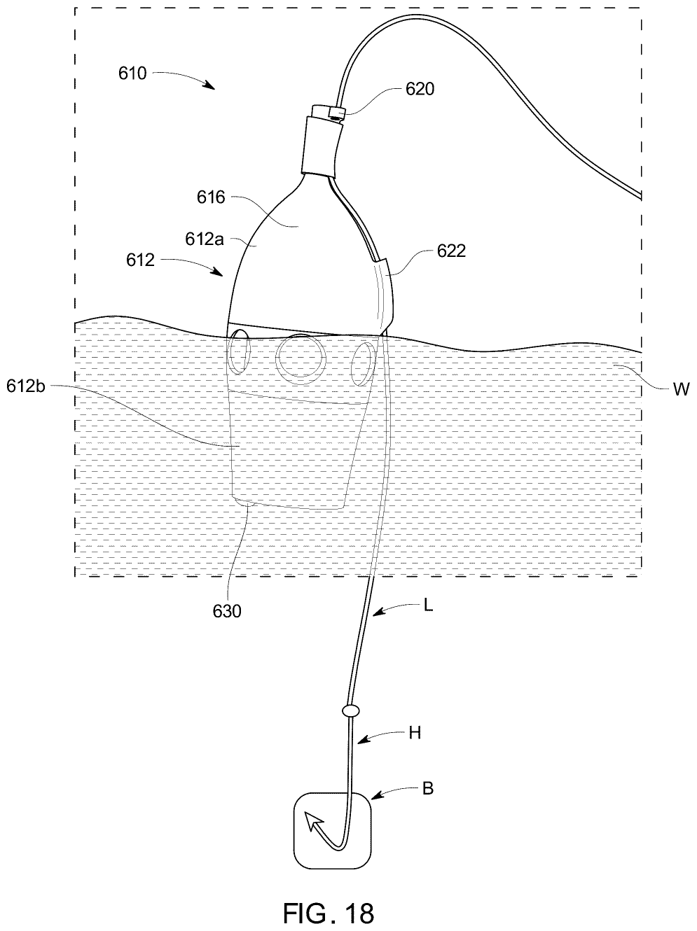

A first line eye 620 may be located at or near the top of the trunk top section 612a. The bobber 610 according to this embodiment includes a second line eye, which may take the form of an external elongated channel 622 along an exterior portion of the trunk 612. As shown in FIG. 17 and FIG. 18, the bobber 610 is secured to the line L, by passing the line L through the first line eye 520, then through the line eye/channel 622 before it is connected to a hook H at the free end of the line L. The line L is secured to the bobber 610 at the first line eye 620 and the depth of the hook H below the surface of the water W is determined by the fisherman by the length of line between the hook H and the point where the line exits the second line eye/channel 622.

As shown in FIG. 17, when there is an insufficient amount of attached weight, the air pocket 616 in the upper section 612a of the trunk 612 and the offset weight 630 in the bottom section 612b cause the bobber 610 to sit on the surface of the water W at an angle, indicating that there is an insufficient amount of attached weight. When there is sufficient attached weight, as shown in FIG. 18, the attached weight B pulls down on the line L causing a cantilevered action at the trunk 612 between the first line eye 620 and second line eye/channel 622. The attached weight pulling down on the line L thus causes the bobber 610 to sit in a more upright position as shown in FIG. 18, indicating to the angler above the surface W that there is sufficient attached weight.

For the embodiment shown in FIG. 17-FIG. 19 when a fish engages the hook H and swims away in a given direction, the point where the line L engages the bottom of the second line eye/channel 622 will be pulled in that direction causing the trunk 612 to rotate in that direction relative to the first line eye 620 which is located substantially at the center of the trunk 612. This rotation indicates to the angler that a fish is on the line and also indicates the direction that the fish is swimming. Contrasting and/or other colors and/or patterns can be added to the upper section 612a of the trunk 612 to provide further visual assistance to the angler in making this determination.

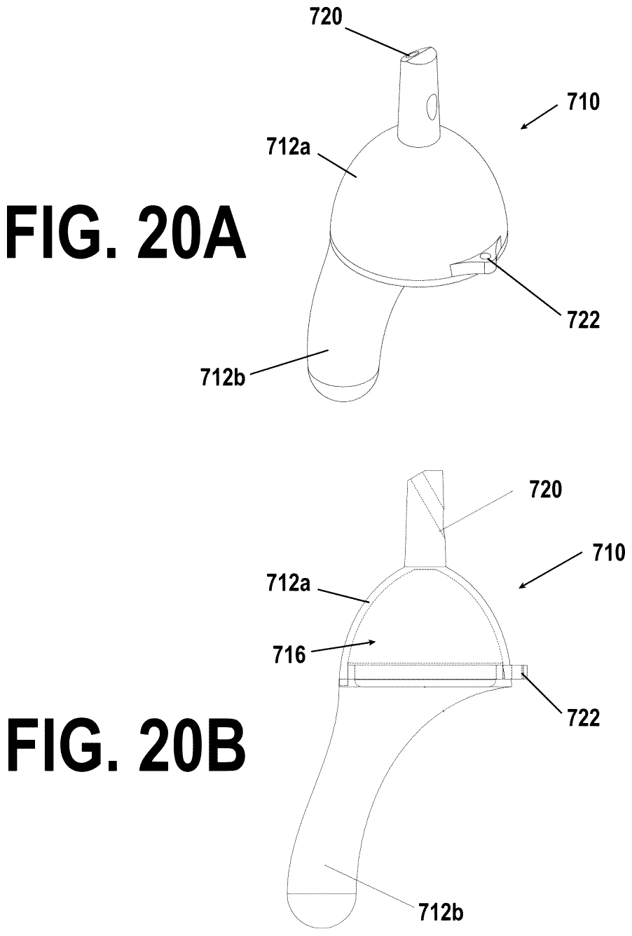

FIG. 20A and FIG. 20B show a bobber 710 according to a further preferred embodiment having a directional indicator and a visual indicator to the angler above the surface of whether there is still bait (weight) on the hook H. As in the prior embodiments, the bobber 710 includes a trunk 712, a top portion 712a of which floats above the surface of the water and a lower, weighted portion 712b that is designed to sit below the surface of the water when in use. The top section 712a of the trunk 712 may include an air pocket 716 to keep the upper portion of the bobber floating above the surface of the water W. The top section 712a and bottom section 712b of the trunk 712 can be molded from plastic and designed to snap together to form the entire trunk 712 having the air pocket 716 in the upper section 712a as shown in FIG. 20B. The bottom section 712b of the trunk is formed from solid plastic with the weighted portion thereof set of to one side from the center point of the trunk 712 to make the bobber counteract the weight associated with bait on the hook causing the bobber 710 to sit upright when there is weight/bait on the hook or to lie on its side when there is no weight/bait on the hook.

A first line attachment point or channel 720 may be located at or near the top of the trunk top section 712a and a second line eye 722 may be located at or near the bottom of the upper trunk section 712a along the outer periphery thereof. The bobber 710 is secured to the line by passing the line through the channel 720, then through the second line eye 722 before it is connected to a hook at the free end of the line. The line is secured to the bobber 710 near the channel 720 by a rubber sleeve that surrounds the line and post through which the channel 720 passes.

This detailed description, and particularly the specific details of the exemplary embodiments disclosed, is given primarily for clearness of understanding and no unnecessary limitations are to be understood herefrom, for modifications will become evident to those skilled in the art upon reading this disclosure and may be made without departing from the spirit or scope of the claimed invention.

I/we claim:

1. A fishing bobber with directional buoyancy indicator for attachment to a fishing line, said bobber comprising:
a. a trunk having a weighted first end and a buoyant second end such that when in use, the weighted first end is below the surface of the water and the buoyant second end is above the surface of the water substantially above the first end;
b. first means for engaging a first segment of the fishing line, said first means for engaging positioned on the buoyant second end of the trunk proximate to a longitudinal centerline of the trunk to create a pivot point;
c. second means for engaging a second segment of the fishing line, said second means for engaging positioned on a component part of the trunk at a radially remote position relative to the first engaging means;
d. wherein the fishing line passes through and engages the first segment of the fishing line at a location closer to a rod from which the fishing line emanates, and the fishing line passes through and engages the second segment of the fishing line at a location closer to a hook at a terminal end of the fishing line.

2. The fishing bobber according to claim 1 wherein the trunk is hollow and includes a plurality of openings in an outer surface thereof between said first weighted end and said second buoyant end.

3. The fishing bobber according to claim 1 wherein the trunk is a cylinder having a first sealed cap at the first weighted end and a second sealed cap at the second buoyant end.

4. The fishing bobber according to claim 1 further comprising a sealed air pocket at the second buoyant end of the trunk for providing buoyancy to the bobber.

5. The fishing bobber according to claim 1 wherein the trunk is formed from a plastic material and the plastic material at the first weighted end has a density greater than the density of the first end of the trunk.

6. The fishing bobber according to claim 1 wherein the component part of the trunk is a limb having a first end affixed to said trunk proximate to the first engaging means and extending radially outwardly therefrom to a second free end of the limb proximate to the second engaging means.

7. The fishing bobber according to claim 6 wherein the limb extends radially outwardly from the trunk in a plane that is substantially perpendicular to a central axis of the trunk.

8. The fishing bobber according to claim 6 wherein the limb extends radially outwardly from the trunk at a downward angle toward the first weighted end of the trunk.

9. The fishing bobber according to claim 6 wherein said first fishing line segment engaging means and said second fishing line segment engaging means each comprise a line eye to which the respective segments of fishing line are secured.

10. The fishing bobber according to claim 6 wherein the limb extends radially outwardly from the trunk at an upward angle away from the first weighted end of the trunk.

11. The fishing bobber according to claim 1 further comprising a weighted magnet located at the weighted first end of the trunk, said magnet providing both weight and means for removably attaching additional weight.

12. The fishing bobber according to claim 1 wherein the component part of the trunk is located on an outer edge of the trunk proximate to a middle region of the trunk.

13. The fishing bobber according to claim 12 wherein the component part is a channel that passes through the trunk with a first opening located in the buoyant second end of the trunk and a second opening at a lower end of the weighted first end of the trunk.

14. The fishing bobber according to claim 13 wherein the weighted first end of the trunk includes a sloped bottom which alters the balance of the bobber putting more weight on one side thereof at the bottom.

15. The fishing bobber according to claim 12 wherein the component part is a line eye affixed to the trunk.

16. The fishing bobber according to claim 12 wherein the component part is an elongated channel extending outwardly from the surface of the trunk.

17. The fishing bobber according to claim 1 wherein a side of the weighted first end that is radially opposite the second means for engaging is heavier causing the bobber to not float in an upright position when there is not sufficiently attached weight.

18. The fishing bobber according to claim 17 wherein a weight is added to the trunk at a position radially opposite the second means for engaging.
